(19) United States
(12) Patent Application Publication
(10) Pub. No.: US 2006/0066719 A1
(43) Pub. Date: Mar. 30, 2006

(54) Method for finding paths in video

(75) Inventors: Niels Haering, Reston, VA (US); Zeeshan Rasheed, Reston, VA (US); Li Yu, Herndon, VA (US); Andrew J. Chosak, Arlington, VA (US); Geoffrey Egnal, Washington, DC (US); Alan J. Lipton, Herndon, VA (US); Haiying Liu, Chantilly, VA (US); Peter L. Venetianer, McLean, VA (US); Weihong Yin, Herndon, VA (US); Liang Yin Yu, Herndon, VA (US); Zhong Zhang, Herndon, VA (US)

Correspondence Address: VENABLE LLP, P.O. BOX 34385, WASHINGTON, DC, 20045-9998, US

(73) Assignee: ObjectVideo, Inc., Reston, VA (US)

(21) Appl. No.: 10/948,751

(22) Filed: Sep. 24, 2004

(51) Int. Cl. H04N 7/18; H04N 9/47; H04N 5/225

(52) U.S. Cl. 348/143; 348/169

(57) ABSTRACT

An input video sequence may be processed by processing the input video sequence to obtain target information; and building at least one path model based on said target information. The path model may be used to detect various events, particularly in connection with video surveillance.

### FIELD OF THE INVENTION

The present invention is related to video surveillance. More specifically, specific embodiments of the invention relate to a context-sensitive video-based surveillance system.

### BACKGROUND OF THE INVENTION

Many businesses and other facilities, such as banks, stores, airports, etc., make use of security systems. Among such systems are video-based systems, in which a sensing device, like a video camera, obtains and records images within its sensory field. For example, a video camera will provide a video record of whatever is within the field-of-view of its lens. Such video images may be monitored by a human operator and/or reviewed later by a human operator. Recent progress has allowed such video images to be monitored also by an automated system, improving detection rates and saving human labor.

In many situations it would be desirable to specify the detection of targets using relative modifiers such as fast, slow, tall, flat, wide, narrow, etc., without quantifying these adjectives. Likewise it would be desirable for state-of-the-art surveillance systems to adapt to the peculiarities of the scene, as current systems are unable to do so, even if the same systems have been monitoring the same scene for many years.

### SUMMARY OF THE INVENTION

Embodiments of the present invention are directed to enabling the automatic extraction and use of contextual information. Furthermore, embodiments of the present invention may provide contextual information about moving targets. This contextual information may be used to enable context-sensitive event detection, and it may improve target detection, improve tracking and classification, and decrease the false alarm rate of video surveillance systems.

In particular, a video processing system according to an embodiment of the invention may include an up-stream video processing device to accept an input video sequence and output information on one or more targets in said input video sequence; and a path builder, coupled to said up-stream video processing device to receive at least a portion of said output information and to build at least one path model.

Furthermore, a method of video processing according to an embodiment of the invention may include processing an input video sequence to obtain target information; and building at least one path model based on said target information.

The invention may be embodied in the form of hardware, software, or firmware, or in the form of combinations thereof.

Definitions

The following definitions are applicable throughout this disclosure, including in the above.
A “video” refers to motion pictures represented in analog and/or digital form. Examples of video include: television, movies, image sequences from a video camera or other observer, and computer-generated image sequences.
A “frame” refers to a particular image or other discrete unit within a video.
An “object” refers to an item of interest in a video. Examples of an object include: a person, a vehicle, an animal, and a physical subject.
A “target” refers to a computer's model of an object. A target may be derived via image processing, and there is a one-to-one correspondence between targets and objects.
A “target instance,” or “instance,” refers to a sighting of an object in a frame.
An “activity” refers to one or more actions and/or one or more composites of actions of one or more objects. Examples of an activity include: entering; exiting; stopping; moving; raising; lowering; growing; and shrinking.
A “location” refers to a space where an activity may occur. A location may be, for example, scene-based or image-based. Examples of a scene-based location include: a public space; a store; a retail space; an office; a warehouse; a hotel room; a hotel lobby; a lobby of a building; a casino; a bus station; a train station; an airport; a port; a bus; a train; an airplane; and a ship. Examples of an image-based location include: a video image; a line in a video image; an area in a video image; a rectangular section of a video image; and a polygonal section of a video image.
An “event” refers to one or more objects engaged in an activity. The event may be referenced with respect to a location and/or a time.
A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer may have a single processor or multiple processors, which may operate in parallel and/or not in parallel. A computer also refers to two or more computers connected together via a network for transmitting or receiving information between the computers. An example of such a computer includes a distributed computer system for processing information via computers linked by a network.
A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.
“Software” refers to prescribed rules to operate a computer. Examples of software include: software; code segments; instructions; computer programs; and programmed logic.
A “computer system” refers to a system having a computer, where the computer comprises a computer-readable medium embodying software to operate the computer.
A “network” refers to a number of computers and associated devices that are connected by communication facilities. A network involves permanent connections such as cables or temporary connections such as those made through telephone or other communication links. Examples of a network include: an internet, such as the Internet; an intranet; a local area network (LAN); a wide area network (WAN); and a combination of networks, such as an internet and an intranet.
A “sensing device” refers to any apparatus for obtaining visual information. Examples include: color and monochrome cameras, video cameras, closed-circuit television (CCTV) cameras, charge-coupled device (CCD) sensors, analog and digital cameras, PC cameras, web cameras, and infra-red imaging devices. If not more specifically described, a “camera” refers to any sensing device.
A “blob” refers generally to any object in an image (usually, in the context of video). Examples of blobs include moving objects (e.g., people and vehicles) and stationary objects (e.g., bags, furniture and consumer goods on shelves in a store).
A “target property map” is a mapping of target properties or functions of target properties to image locations. Target property maps are built by recording and modeling a target property or function of one or more target properties at each image location. For instance, a width model at image location (x,y) may be obtained by recording the widths of all targets that pass through the pixel at location (x,y). A model may be used to represent this record and to provide statistical information, which may include the average width of targets at location (x,y), the standard deviation from the average at this location, etc. Collections of such models, one for each image location, are called a target property map.
A “path” is an image region, not necessarily connected, that represents the loci of targets: a) whose trajectories start near the start point of the path; b) whose trajectories end near the end point of the path; and c) whose trajectories overlap significantly with the path.

### BRIEF DESCRIPTION OF THE DRAWINGS

Specific embodiments of the invention will now be described in further detail in conjunction with the attached drawings, in which:

FIG. 1 depicts a flowchart of a content analysis system that may include embodiments of the invention;

FIG. 2 depicts a flowchart describing training of paths, according to an embodiment of the invention;

FIG. 3 depicts a flowchart describing the training of target property maps according to an embodiment of the invention;

FIG. 4 depicts a flowchart describing the use of target property maps according to an embodiment of the invention; and

FIG. 5 depicts a block diagram of a system that may be used in implementing some embodiments of the invention.

### DETAILED DESCRIPTION OF VARIOUS EMBODIMENTS OF THE INVENTION

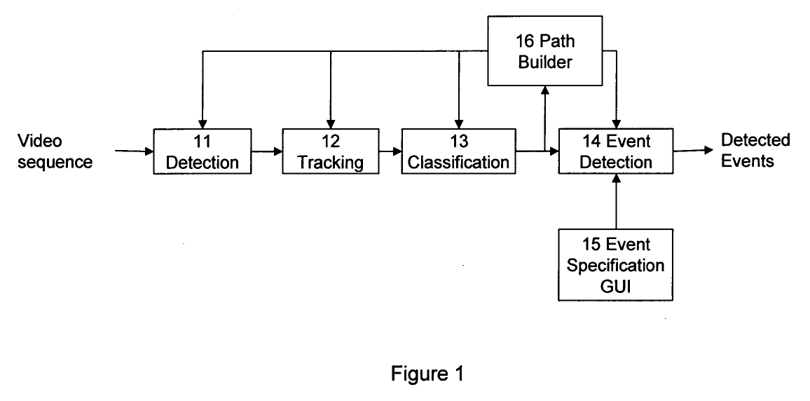

This invention may comprise part of a general surveillance system. A potential embodiment is illustrated in FIG. 1. Target property information is extracted from the video sequence by detection (11), tracking (12) and classification (13) modules. These modules may utilize known or as yet to be discovered techniques. The resulting information is passed to an event detection module (14) that matches observed target properties against properties deemed threatening by a user (15). For example, the user may be able to specify such threatening properties by using a graphical user interface (GUI) (15) or other input/output (I/O) interface with the system. The path builder (16) monitors and models the data extracted by the up-stream components (11), (12), and (13), and it may further provide information to those components. Data models may be based on target properties, which may include, but which are not limited to, the target's location, width, height, size, speed, direction-of-motion, time of sighting, age, etc. This information may be further filtered, interpolated and/or extrapolated to achieve spatially and temporally smooth and continuous representations.

Learning Paths by Observation

According to some embodiments of the invention, paths need to be learned by observation before they can be used. To signal the validity of a path model it is labeled “mature” only after a statistically meaningful amount of data has been observed. Queries to path models that have not yet matured are not answered. This strategy leaves the system in a default mode until at least some of the models have matured. When a path model has matured, it may provide information that may be incorporated into the decision making processes of connected algorithmic components. The availability of this additional information may help the algorithmic components to make better decisions.

Not all targets or their instances are necessarily used for training. The upstream components (11), (12), and (13) that gather target properties may fail, and it is important that the models are shielded from data that is faulty. One technique for dealing with this problem is to devise algorithms that carefully analyze the quality of the target properties. In other embodiments of the invention, a simple algorithm may be used that rejects targets and target instances if there is a doubt about their quality. This latter approach likely extends the time until target property maps achieve maturity. However, the prolonged time that many video surveillance systems spend viewing a scene makes this option attractive in that the length of time to maturity is not likely to be problematic.

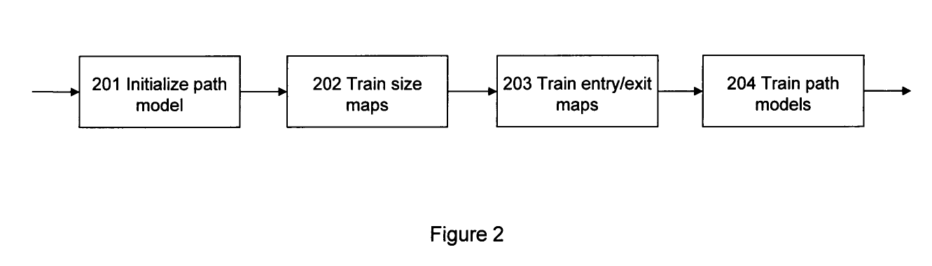

An overview of the algorithm for learning path models according to an embodiment of the invention is shown in FIG. 2. The major components may include initialization of the path model (201), training of size maps (202), training of entry/exit maps (203), and training of path models (204).

Size maps may be generated in Block 202 and may be used by the entry/exit map training algorithm (203) to associate trajectories with entry/exit regions. Entry/exit regions that are close compared to the normal size of the targets that pass through them are merged. Otherwise they are treated as separate entry/exit regions.

Entry/exit maps, which may be generated in Block 203, may in turn form the basis for path models. When entry/exit regions have matured they can be used to measure target movement statistics between them. These statistics may be used to form the basis for path models in Block 204.

The size and entry/exit maps are types of target property maps, and they may be trained (built) using a target property map training algorithm, which is described in co-pending, commonly-assigned U.S. patent application No. 10/______, filed on Sep. 24, 2004, entitled, “Target Property Maps for Surveillance Systems,” and incorporated herein by reference. The target property map training algorithm may be used several times in the process shown in FIG. 2. To simplify the description of this process, the target property map training algorithm is explained here in detail and then referenced later in the algorithm detailing the extraction of path models.

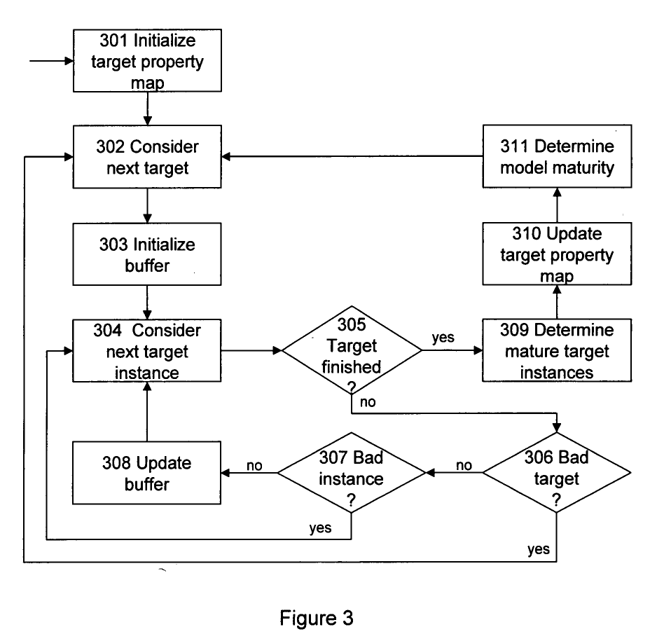

FIG. 3 depicts a flowchart of an algorithm for building target property maps, according to an embodiment of the invention. The algorithm may begin by appropriately initializing an array corresponding to the size of the target property map (in general, this may be correspond to an image size) in Block 301. In Block 302, a next target may be considered. This portion of the process may begin with initialization of a buffer, which may be a ring buffer, of filtered target instances, in Block 303. The procedure may then proceed to Block 304, where a next instance (which may be stored in the buffer) of the target under consideration may be addressed. In Block 305, it is determined whether the target is finished; this is the case if all of its instances have been considered. If the target is finished, the process may proceed to Block 309 (to be discussed below). Otherwise, the process may then proceed to Block 306, to determine if the target is bad; this is the case if this latest instance reveals a severe failure of the target's handling, labeling or identification by the up-stream processes. If this is the case, the process may loop back to Block 302, to consider the next target. Otherwise, the process may proceed with Block 307, to determine if the particular instance under consideration is a bad instance; this is the case if the latest instance reveals a limited inconsistency in the target's handling, labeling or identification by the up-stream process. If a bad instance was found, that instance is ignored and the process proceeds to Block 304, to consider the next target instance. Otherwise, the process may proceed with Block 308 and may update the buffer of filtered target instances, before returning to Block 304, to consider the next target instance.

Following Block 305 (as discussed above), the algorithm may proceed with Block 309, where it is determined which, if any, target instances may be considered to be “mature.” According to an embodiment of the invention, if the buffer is found to be full, the oldest target instance in the buffer may be marked “mature.” If all instances of the target have been considered (i.e., if the target is finished), then all target instances in the buffer may be marked “mature.”

The process may then proceed to Block 310, where target property map models may be updated at the map locations corresponding to the mature target instances. Following this map updating, the process may determine, in Block 311, whether or not each model is mature. In particular, if the number of target instances for a given location is larger than a preset number of instances required for maturity, the map location may be marked “mature.” As discussed above, only mature locations may be used in addressing inquiries.

Returning, now, to the process of FIG. 2, the target property map training algorithm of FIG. 3 will be referenced in describing the process of training path models. As discussed above, in Block 201, a path model may be initialized at the outset of the process. This may be done, for example, by initializing an array, which may be the size of an image (e.g., of a video frame).

The process of FIG. 2 may then proceed to Block 202, training of size maps. In an embodiment of the invention, the process of Block 202 uses the target property map training algorithm of FIG. 3 to train one or more size maps. The generic target property training algorithm of FIG. 3 may be changed to perform this particular type of training by modifying Blocks 301, 308, and 310. All three of these blocks, in Block 202 of FIG. 2, operate on size map instances of the generic target property map objects. Component 308 extracts size information from the target instance stream that enters the path builder (component 16 in FIG. 1). Separate size maps may be maintained for each target type and for several time ranges.

The process of FIG. 2 may then train entry/exit region maps (Block 203). Once again, the algorithm of FIG. 3 may be used to perform the map training. To do so, the instantiations of the initialization component (301), the extraction of target origin and destination information (308), and the target property model update component (310) may all be changed to suit this particular type of map training. Component 301 may operate on entry/exit map instances of the generic target property map objects. Component 308 may extract target scene entry and exit information from the target instance stream that enters the path builder (component 16 in FIG. 1). Component 309 may determine a set of entry and exit regions that represent a statistically significant number of trajectories. These regions are deemed to deserve representation and may be annotated with target statistics, such as, but not limited to, the region size and location, the percentage of targets in the scene that enter or exit through the region, etc. Component 310 may update the entry/exit region model to reflect changes to the shapes and/or target coverages of the entry/exit regions. This process may use information provided by a size map trained in Block 202 to decide whether adjacent entry or exit regions need to be merged. Entry regions that are close to each other may be merged into a single region if the targets that use them are large compared to the distance between them. Otherwise, they may remain separate regions. The same approach may be used for exit regions. This enables maintaining separate paths even when the targets on them appear to be close to each other at a great distance from the camera. The projective transformation that controls image formation is the cause for the apparent close proximity of distant objects. One may use the ratio of target size over entry/exit region distance,

$$\frac{\text{target size}}{\text{distance between regions}} ,$$

as it is practically invariant under perspective transformation and thus simplifies the region maintenance algorithm. Separate size maps may be maintained for each target type and for several time ranges.

Path models may then be trained, Block 204. According to an embodiment of the invention, this may begin with initialization of a path data structure. The process may then use the information contained in the entry and exit region map to build a table with a row for each entry region and a column for every exit region in the entry and exit region map. Each trajectory may be associated with an entry region from which it originates and an exit region where it terminates. The set of trajectories associated with an entry/exit region pair is used to define the locus of the path. According to various embodiments of the invention, a path may be determined by taking the intersection of all trajectories in the set, by taking the union of those trajectories, or by defining a path to correspond to some minimum percentage of trajectories in the set. The path data structure combines the information gathered about each path: the start and end points of the path, the number or fraction of trajectories it represents, and two indices into the entry/exit region map that indicate which entry and exit regions in that data structure it corresponds to. Separate path models may be maintained for each type of target and for several time ranges.

Using Path Models

The algorithm just described details how path models ma y be obtained and maintained using information from an existing surveillance system. However, to make them useful to the surveillance system they must also be able to provide information to the system. The possible benefits to a video surveillance system include:
Prediction of the target's destination, given its location and its observed trajectory
Classification of the target's path
Detection of unusual target properties
   Target deviates from its path
   Target switches paths
   Target crosses paths
   Target travels on an infrequently used path
   Target travels unusually slow, unusually fast or stops where targets don't usually stop
   Target travels on a path, but at an unusual time
   Target travels on a path, but at in unusual direction
   Target travels on a path, that is not normally associated with targets of this type
   The properties of the target on a certain path are unusual (in width, height, size, area, target perimeter length, color (hue, saturation, luminance), texture, compactness, shape or temporal appearance).

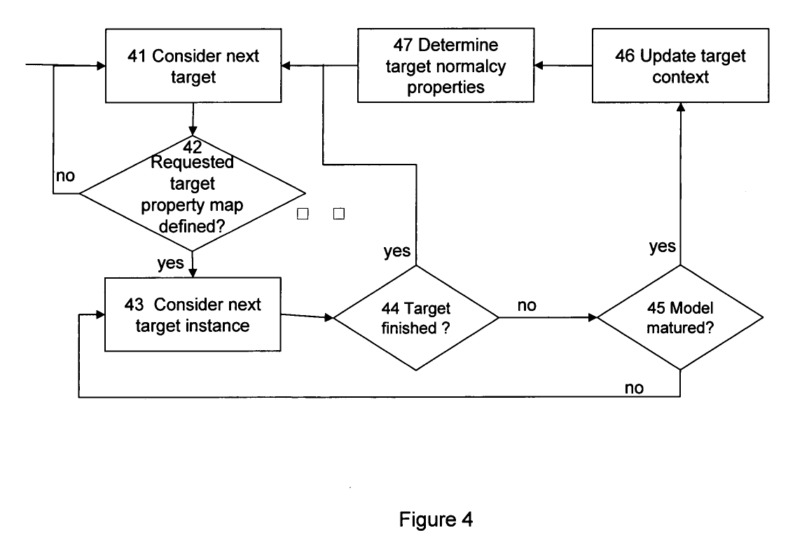

FIG. 4 depicts a flowchart of an algorithm for querying path models (e.g., by one or more components of a surveillance system) to obtain contextual information, according to an embodiment of the invention.

The algorithm of FIG. 4 may begin by considering a next target, in Block 41. It may then proceed to Block 42, to determine if the requested path model has been defined. If not, the information about the target is unavailable, and the process may loop back to Block 41, to consider a next target.

If the requested path model is determined to be available, the process may then consider a next target instance, in Block 43. If the instance indicates that the target is finished, in Block 44, the process may loop back to Block 41 to consider a next target. A target is considered finished if all of its instances have been considered. If the target is not finished, the process may proceed to Block 45 and may determine if the target property map model at the location of the target instance under consideration has matured. If it has not matured, the process may loop back to Block 43 to consider a next target instance. Otherwise, the process may proceed to Block 46, where target context may be updated. The context of a target is updated by recording the degree of its conformance with the target property map maintained by this algorithm. Following Block 46, the process may proceed to Block 47 to determine normalcy properties of the target based on its target context. The context of each target is maintained to determine whether it acted in a manner that is inconsistent with the behavior or observations predicted by the target property map model. Finally, following Block 47, the procedure may return to Block 41 to consider a next target.

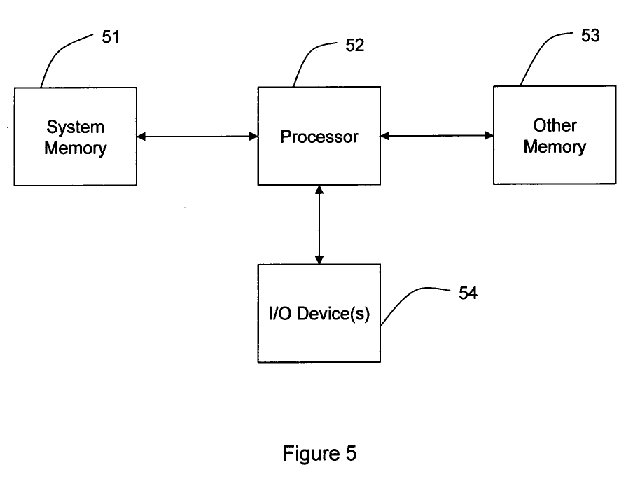

Some embodiments of the invention, as discussed above, may be embodied in the form of software instructions on a machine-readable medium. Such an embodiment is illustrated in FIG. 5. The computer system of FIG. 5 may include at least one processor 52, with associated system memory 51, which may store, for example, operating system software and the like. The system may further include additional memory 53, which may, for example, include software instructions to perform various applications. The system may also include one or more input/output (I/O) devices 54, for example (but not limited to), keyboard, mouse, trackball, printer, display, network connection, etc. The present invention may be embodied as software instructions that may be stored in system memory 51 or in additional memory 53. Such software instructions may also be stored in removable or remote media (for example, but not limited to, compact disks, floppy disks, etc.), which may be read through an I/O device 54 (for example, but not limited to, a floppy disk drive). Furthermore, the software instructions may also be transmitted to the computer system via an I/O device 54 for example, a network connection; in such a case, a signal containing the software instructions may be considered to be a machine-readable medium.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A video processing system comprising:
an up-stream video processing device to accept an input video sequence and output information on one or more targets in said input video sequence; and
a path builder, coupled to said up-stream video processing device to receive at least a portion of said output information and to build at least one path model.

2. The system according to claim 1, wherein said up-stream video processing device comprises:
a detection device to receive said input video sequence;
a tracking device coupled to an output of said detection device; and
a classification device coupled to an output of said tracking device, an output of said classification device being coupled to an input of said path builder.

3. The system according to claim 1, further comprising:
an event detection device coupled to receive an output of said path builder and to output one or more detected events.

4. The system according to claim 3, further comprising:
an event specification interface coupled to said event detection device to provide one or more events of interest to said event detection device.

5. The system according to claim 4, wherein said event specification interface comprises a graphical user interface.

6. The system according to claim 1, wherein said path builder provides feedback to said up-stream video processing device.

7. The system according to claim 1, wherein said path builder comprises:
at least one buffer.

8. A method of video processing, comprising:
processing an input video sequence to obtain target information; and
building at least one path model based on said target information.

9. The method according to claim 8, wherein said processing an input video sequence comprises:
detecting at least one target;
tracking at least one target; and
classifying at least one target.

10. The method according to claim 8, wherein said building at least one path model comprises:
building at least one size map;
building at least one of the group consisting of entry maps and exit maps; and
training said at least one path model based on said at least one of the group consisting of an entry map and an exit map.

11. The method according to claim 10, wherein at least one of the group consisting of said building at least one size map and building at least one of the group consisting of entry maps and exit maps comprises:
for a given target, considering at least one instance of the target;
filtering said at least one instance of the target; and
determining if said at least one instance of the target is mature.

12. The method according to claim 11, wherein said at least one of the group consisting of said building at least one size map and building at least one of the group consisting of entry maps and exit maps further comprises:
if at least one instance of the target is mature, updating at least one map model corresponding to at least one location where an instance of the target is mature.

13. The method according to claim 12, wherein said wherein at least one of the group consisting of said building at least one size map and building at least one of the group consisting of entry maps and exit maps further comprises:
determining if at least one map model forming part of said at least path model is mature.

14. The method according to claim 8, further comprising:
detecting at least one event based on said at least one path model.

15. The method according to claim 14, wherein said detecting at least one event comprises:
for a given target, comparing at least one path of the target with at least one path of said at least one path model.

16. The method according to claim 15, wherein said comparing comprises:
using a user-defined comparison criterion.

17. The method according to claim 14, further comprising:
obtaining at least one user-defined criterion for event detection.

18. A computer-readable medium containing instructions that, when executed by a processor, cause the processor to perform the method according to claim 8.

19. A video processing system comprising:
a computer system; and
the computer-readable medium according to claim 18.

20. A video surveillance system comprising:
at least one camera to generate an input video sequence; and
the video processing system according to claim 19.
